(19) United States
(12) Patent Application Publication
(10) Pub. No.: US 2026/0120329 A1
(43) Pub. Date: Apr. 30, 2026

(54) METHOD FOR ENCODING DYNAMIC MESH, APPARATUS FOR PERFORMING THE METHOD AND RECORDING MEDIUM STORING THE METHOD FOR ENCODING DYNAMIC MESH

(71) Applicant: Electronics and Telecommunications Research Institute, Daejeon (KR)

(72) Inventors: Da Yun NAM, Daejeon (KR); Seong Yong LIM, Daejeon (KR)

(73) Assignee: Electronics and Telecommunications Research Institute, Daejeon (KR)

(21) Appl. No.: 19/368,098

(22) Filed: Oct. 24, 2025

(30) Foreign Application Priority Data
Oct. 25, 2024 (KR) 10-2024-0147958

(51) Int. Cl. G06T 9/00

(52) U.S. Cl. CPC G06T 9/001

(57) ABSTRACT

A method of encoding a dynamic mesh according to the present disclosure may comprise: obtaining a base mesh from an input mesh; subdividing the base mesh; generating displacement information based on subdivided mesh; and encoding the base mesh and the displacement information, wherein the base mesh is obtained by performing mesh decimation on the input mesh, and wherein a decimation parameter for the mesh decimation is determined in a unit of region in the input mesh.

This application claims the benefit under 35 USC § 119 (a) of Korean Patent Application No. 10-2024-0147958 filed on Oct. 25, 2024, in the Korean Intellectual Property Office, the entire disclosure of which is incorporated herein by reference for all purposes.

### BACKGROUND OF THE INVENTION

### Field of the Invention

The present disclosure relates to a method of encoding/decoding a dynamic mesh.

### Description of the Related Art

Static or dynamic 2D data may generally be encoded/decoded using image or video compression codecs such as AVC, HEVC or VVC. Due to high compression performance of the compression codecs, a method of using the compression codecs to compress immersive video or mesh has continuously been studied.

### SUMMARY OF THE INVENTION

It is an object of the present disclosure to provide a method of determining at least one of whether to perform mesh decimation or an intensity of mesh decimation for each region.

It is a further object of the present disclosure to provide a method of performing mesh subdivision, mesh transformation or mesh quantization based on mesh decimation information.

It is a further object of the present disclosure to provide a method of encoding/decoding a coding parameter in units of coding units generated by partitioning an input mesh.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of encoding a dynamic mesh, the method comprising obtaining a base mesh from an input mesh; subdividing the base mesh; generating displacement information based on subdivided mesh; and encoding the base mesh and the displacement information, wherein the base mesh is obtained by performing mesh decimation on the input mesh, and wherein a decimation parameter for the mesh decimation is determined in a unit of region in the input mesh.

In the method of encoding the dynamic mesh according to the present disclosure, a decimation parameter for a current region in the input mesh is determined based on a local spatial characteristic of the current region.

In the method of encoding the dynamic mesh according to the present disclosure, the local spatial characteristic comprises at least one of a number of vertices in the current region, a number of faces in the current region, a number of edges in the current region, a length of an edge or an importance of the current region.

In the method of encoding the dynamic mesh according to the present disclosure, the decimation parameter comprises at least one of a target vertex count ratio, a target face count ratio, a target number of vertices, a target number of faces or a threshold value of an importance, the target vertex count ratio represents a ratio between a number of vertices in the current region in the input mesh and a number of vertices in the current region in a decimated mesh, and wherein the target face count ratio represent a ratio between a number of faces in the current region in the input mesh and a number of faces in the current region in the decimated mesh.

In the method of encoding the dynamic mesh according to the present disclosure, based on a comparison result between a length of an edge in the current region with a threshold value, it is determined whether to remove a vertex constituting the edge.

In the method of encoding the dynamic mesh according to the present disclosure, when the length of the edge is greater than the threshold value, the vertex is preserved, and when the length of the edge is equal to or less than the threshold value, the vertex is removed.

In the method of encoding the dynamic mesh according to the present disclosure, the decimation parameter comprises at least one of information indicating whether to perform a contraction, a number of iterations for the contraction, a minimum number of iterations for the contraction, a maximum number of iterations for the contraction or a threshold value of an importance.

In the method of encoding the dynamic mesh according to the present disclosure, when it is determined to perform the contraction for the current region, at least one of a pair contraction or an edge contraction is performed for the current region.

In the method of encoding the dynamic mesh according to the present disclosure, after performing the contraction for the current region, the local spatial characteristic of the current region is updated, and based on the updated local spatial characteristic, it is determined whether the contraction is to be performed again for the current region.

In the method of encoding the dynamic mesh according to the present disclosure, a decimation parameter for a current region in the input mesh is determined by comparing a plurality of coding performance metrics for the current.

In the method of encoding the dynamic mesh according to the present disclosure, the coding performance metrics represent rate-distortion costs obtained by varying a decimation parameter for the current region.

In the method of encoding the dynamic mesh according to the present disclosure, the decimation parameter for the current region is determined based on a setting used to obtain an optimal coding performance metric among the plurality of coding performance metrics.

In the method of encoding the dynamic mesh according to the present disclosure, the method further comprises encoding mesh decimation information, and the mesh decimation information is encoded and signaled for each region.

In the method of encoding the dynamic mesh according to the present disclosure, based on the decimation parameter, at least one of a number of iterations for the subdivision, a subdivision method or a subdivision edge length threshold is determined.

In the method of encoding the dynamic mesh according to the present disclosure, the method further comprises encoding outlier information, and the outlier information represents information about an abnormal vertex or region resulting from the mesh decimation.

In the method of encoding the dynamic mesh according to the present disclosure, the method further comprises encoding feature information, and the feature information comprises information on vertices with high importance in the input mesh or the base mesh.

In the method of encoding the dynamic mesh according to the present disclosure, the input mesh, the subdivided mesh or a reconstructed mesh is partitioned into a plurality of geometric coding units.

In the method of encoding the dynamic mesh according to the present disclosure, the plurality of geometric coding units represent polygons resulting from the mesh decimation or bounding boxes, each of which includes a polygon resulting from the mesh decimation.

Meanwhile, in the present disclosure, it is possible to provide a computer-readable recording medium recording instructions for implementing the method of encoding/decoding the dynamic mesh.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of an encoder for encoding a dynamic mesh;

FIG. 2 is a block diagram of a decoder for decoding the dynamic mesh;

FIG. 3 illustrates an example where the original mesh information is significantly lost due to mesh simplification.

FIG. 4 illustrates the changes in mesh restoration quality and the amount of encoded/decoded data depending on an intensity of the mesh decimation.

FIG. 5 illustrates a flowchart of an adaptive mesh decimation method according to an embodiment of the present disclosure.

FIGS. 6 and 7 illustrate examples in which the target face count ratio is set differently for each region.

FIG. 8 illustrates an example in which whether to remove a current vertex is determined based on the result of comparing a length of an edge originating from the current vertex with a threshold.

FIG. 9 illustrates examples of edge contraction and pair contraction.

FIG. 10 illustrates an example in which whether to perform a contraction process, or the number of contraction operations is determined differently between regions.

FIG. 11 illustrates feature points within a mesh.

FIG. 12 illustrates an example in which an intensity of mesh decimation is set differently depending on a distance from a feature point.

FIG. 13 illustrates an example of an abnormal region occurring due to mesh decimation.

FIG. 14 illustrates hierarchical partitioning of an image.

FIG. 15 illustrates an example of a mesh divided into a plurality of sub-meshes.

FIG. 16 illustrates an example of partitioning an input mesh into a plurality of GCUs.

FIG. 17 illustrates an example of setting a decimated 3D polygon obtained through mesh decimation as a GCU.

FIG. 18 illustrates an example of determining a GCU based on the BVH partitioning structure.

FIGS. 19A and 19B illustrate an example of setting a bounding volume.

FIG. 20 illustrates an example of determining GCUs based on feature information.

### DETAILED DESCRIPTION OF THE INVENTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. For example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. For example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

Dynamic mesh refers to mesh content whose geometry, attribute, and connectivity information change over time. The dynamic mesh may be separated into geometry information and attribute information. That is, the encoding and decoding of a dynamic mesh may involve encoding and decoding the geometry information and the attribute information independently.

The geometry information may include vertices constituting the dynamic mesh, the connectivity between vertices, and information regarding faces, where each face may be a triangular shape formed by three vertices. The geometry information may represent the positions of vertices in three-dimensional space. Through preprocessing, the geometry information may be further divided into a base mesh and displacement information.

The base mesh may be obtained by applying at least one of mesh decimation or geometry parameterization to the original mesh. The base mesh may be encoded and decoded using a static mesh codec, such as Draco or TFAN.

The displacement information may represent the difference between a fitted mesh generated through subdivision surface fitting and a subdivided base mesh. The displacement information may be encoded and decoded using a conventional video codec, such as HEVC, VVC, or AV1, or using an arithmetic codec.

The attribute information may include an attribute map or a texture map. Through a texture transfer process, the attribute map may be updated or regenerated. The texture transfer may involve re-parameterizing the attribute map of the original mesh to correspond to the reconstructed deformed mesh. The attribute information may be encoded and decoded using a conventional video codec, such as HEVC, VVC, or AV1.

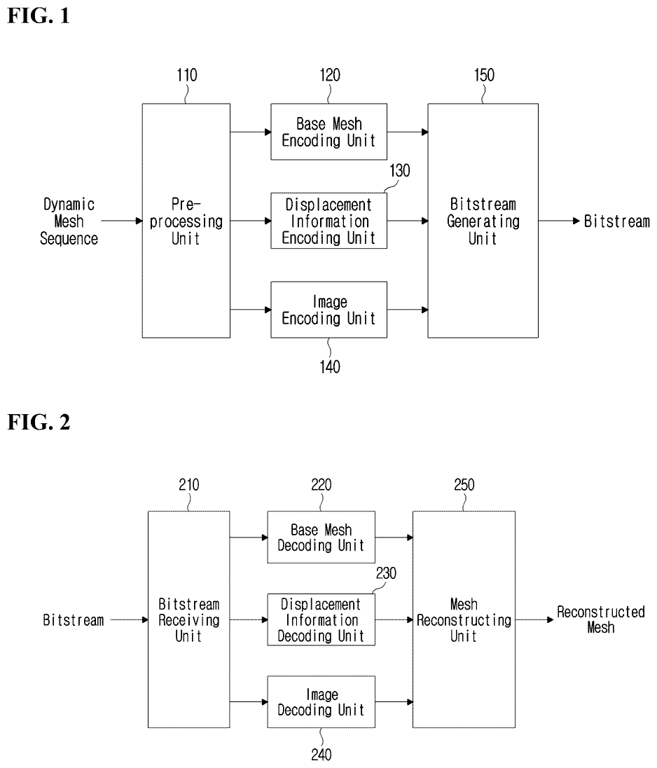

FIG. 1 is a block diagram of an encoder for encoding a dynamic mesh.

Referring to FIG. 1, the encoder may include a pre-processing unit 110, a base mesh encoding unit 120, a displacement information encoding unit 130, an image encoding unit 140, and a bitstream generating unit 150.

The pre-processing unit 110 separate geometric information of a dynamic mesh into base mesh and displacement information. To this end, the pre-processing unit 110 may perform at least one of mesh decimation, mesh parametrization, or mesh subdivision.

Mesh decimation refers to a process of reducing the number of vertices included in a mesh in order to decrease the amount of data to be encoded/decoded. Through the mesh decimation process, vertices with low importance are removed, and a base mesh may be generated. That is, the base mesh may have fewer vertices and faces than the original mesh. A vertex included in the base mesh may be referred to as a basic vertex.

Mesh parameterization refers to the process of providing coordinate system transformations for efficient mesh mapping and processing. Mesh parameterization facilitates the process of assigning attribute information to the shape and structure of a mesh.

As the number of vertices included in the mesh decreases, mesh restoration quality in the decoder more deteriorates. To reduce this problem, additional vertices may be generated by applying mesh subdivision technique to the base mesh. That is, mesh subdivision may represent to generate more vertices by subdividing polygons of the mesh. Through mesh subdivision, the resolution of the mesh is increased, and accordingly, a subdivided mesh with a more precise shape is obtained. A subdivided mesh may include an additional vertex generated through mesh subdivision in addition to basic vertices.

The pre-processing unit 110 may generate a 2D image by packing attribute information of each face included in the mesh into a 2D plane. Further, the pre-processing unit 110 may generate mapping information between a face packed in the 2D image and a face of the reconstructed mesh. Meanwhile, a group of attribute information packed in 2D image may be referred to as a patch.

The pre-processing unit 110 may generate displacement information for the subdivided mesh. The displacement information may include a displacement vector representing a difference between a position of a vertex in the subdivided mesh and a position of a corresponding vertex in a fitted mesh. The fitted mesh may be an approximated one to resemble the original mesh.

The base mesh encoding unit 120, the displacement information encoding unit 130, and the image encoder 140 each encode data generated through the pre-processing unit 110.

Specifically, the base mesh encoding unit 120 encodes the base mesh generated in the preprocessing unit 110.

Meanwhile, the base mesh may be encoded through an intra mode or an inter mode. When the inter mode is applied, a base mesh of a current frame may be derived based on a base mesh of a reference frame. Specifically, by compensating for motion of each vertex in the base mesh of the reference frame, the base mesh for the current frame may be derived.

When the base mesh is encoded in the inter mode, motion information may be encoded and signaled.

The displacement information encoding unit 130 encodes displacement information about vertices included in the subdivided mesh. Here, the displacement information is used to determine a position of a vertex in a 3D space and may include a displacement vector. The displacement vector represents a difference between a current position of a vertex in the subdivided mesh and a position of the corresponding vertex in the fitted mesh.

The image encoding unit 140 encodes attribute information. As an example, the image encoding unit 140 may encode a 2D image in which texture information (e.g., color information) of a mesh face (i.e., a surface of mesh) is packed.

The bitstream generating unit 150 multiplexes the encoded data and generates a bitstream.

Meanwhile, metadata may be generated and encoded so that a reverse process of a preprocessing process performed in the pre-processing unit 110 of the encoder may be performed. The bitstream may further include the metadata.

FIG. 2 is a block diagram of a decoder for decoding a dynamic mesh.

Referring to FIG. 2, the decoder may include a bitstream receiving unit 210, a base mesh decoding unit 220, a displacement information decoding unit 230, an image decoding unit 240, and a mesh reconstruction unit 250.

The bitstream receiving unit 210 demultiplexes the received bitstream and derives a plurality of pieces of encoded data. As an example, encoded attribute data, encoded base mesh data, and encoded displacement data may be derived through bitstream demultiplexing.

The base mesh decoding unit 220 decodes the encoded base mesh. Meanwhile, the base mesh may be decoded through the intra mode or the inter mode. When the inter mode is applied, the base mesh of the current frame may be derived based on the base mesh of the reference frame.

The displacement information decoding unit 230 decodes the encoded displacement information. The displacement information is used to determine a position of a vertex in the 3D space and may include a displacement vector.

The image decoding unit 240 decodes the attribute information. As an example, the image decoding unit 240 may decode a 2D image in which a plurality of patches is packed. The mesh reconstruction unit 250 performs mesh subdivision on the decoded base mesh, adds the displacement information to the subdivided mesh, and reconstructs the geometric information of the mesh. In addition, the mesh reconstructing unit 250 may reconstruct the mesh by adding decoded attribute information to the mesh.

As described above, by creating a base mesh through mesh decimation and encoding/decoding the base mesh instead of the original mesh, data that needs to be encoded/decoded may be reduced. However, when reconstructing a mesh using only the base mesh, there is a problem that the quality of the reconstructed mesh is degraded. To prevent this problem, additional vertices may be generated by performing subdivision on the base mesh. The decoder may generate additional vertices by performing mesh subdivision on the base mesh in the same way as in the encoder.

As described above, mesh decimation directly impacts the quality and amount of data of the base mesh. However, because mesh decimation was previously controlled solely by the target triangle count ratio, it was difficult to improve or control the quality of the base mesh. Degradation of the base mesh quality may negatively impact not only reconstruction of geometric information but also reconstruction of texture information.

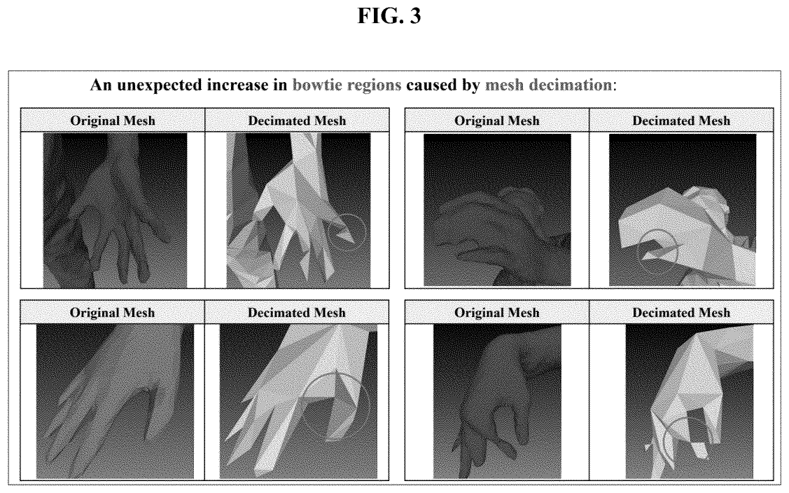

FIG. 3 illustrates an example where the original mesh information is significantly lost due to mesh simplification.

The example in FIG. 3 illustrates an example where vertices representing a finger in the original mesh are changed to a single vertex or edge in the base mesh (or decimated mesh) generated through mesh decimation. Here, an edge represents a line connecting two vertices.

As shown in the example in FIG. 3, the region where separate mesh regions are connected by a single vertex or edge may be referred to as a bowtie region.

To address this problem, the present disclosure proposes an adaptive mesh decimation method.

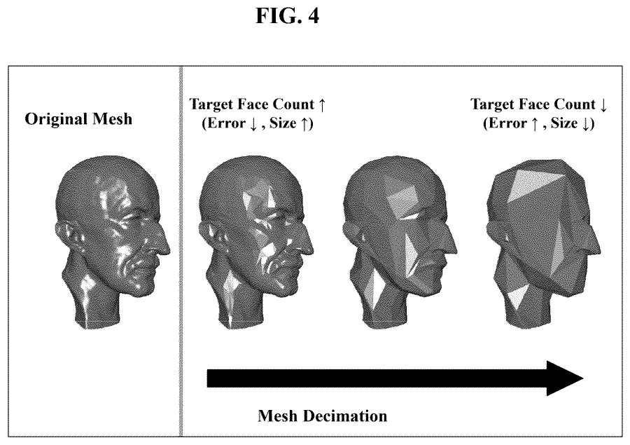

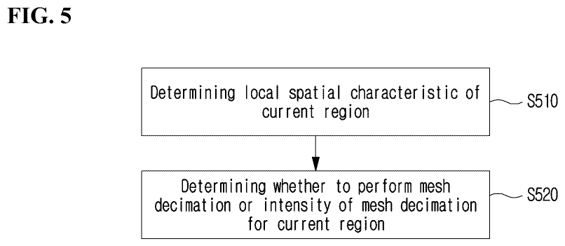

FIG. 4 illustrates the changes in mesh restoration quality and the amount of encoded/decoded data depending on an intensity of the mesh decimation.

As shown in the example shown in FIG. 4, as the intensity of the mesh decimation increases, the mesh restoration quality deteriorates, while the amount of data to be encoded/decoded decreases.

In the present disclosure, in order to improve the quality and encoding efficiency of a base mesh, a method is proposed for adaptively determining, for each region within input data (i.e., an original mesh), at least one of whether to apply mesh decimation or an intensity of mesh decimation. In other words, through the adaptive mesh decimation proposed in the present disclosure, the mesh shape may be simplified and the amount of information to be encoded/decoded may be significantly reduced, while the mesh restoration quality may also be improved by adjusting the intensity of mesh decimation for each region.

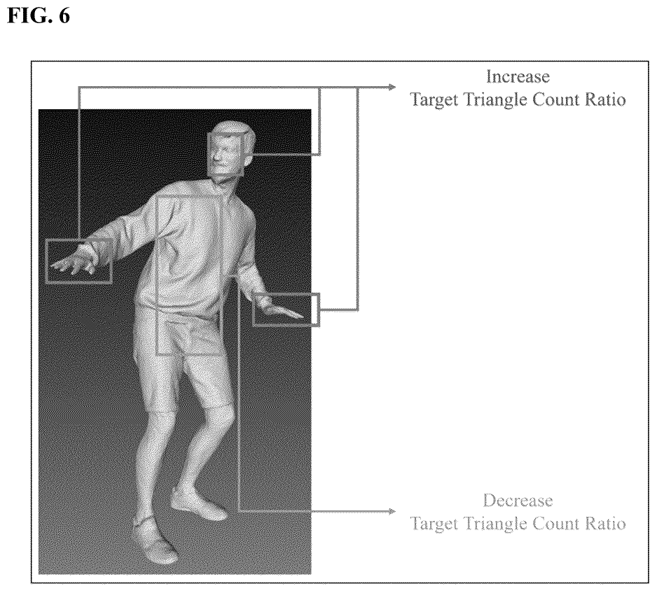

FIG. 5 illustrates a flowchart of an adaptive mesh decimation method according to an embodiment of the present disclosure.

For convenience of explanation, it is assumed that the input mesh is divided into a plurality of regions. A region may be defined in units of vertices, in units of edges, in units of faces, in units of polygons, in units of 3D shapes, in units of sub-meshes or in units of meshes.

For example, defining a region in units of vertices may represent that each region is comprised of a preset number of vertices. Alternatively, defining a region in units of on faces may represent that each region is comprised of a preset number of faces. Here, the preset number may be a natural number of 1 or more.

When a mesh is input, at least one of a global spatial characteristic of the input mesh or a local spatial characteristic of the current region may be determined S510.

The global spatial characteristic may comprise at least one of the number of vertices constituting the input mesh, the number of faces constituting the input mesh, a size of a face, an absolute value of an edge length, or a relative value of an edge length.

The local spatial characteristic may comprise at least one of the number of vertices within the current region, the number of vertices per volume unit, the number of faces withing the current region, a size of a face, the number of faces per volume unit, the number of edges, an absolute value of an edge length, a relative value of an edge length, or an importance of the current region. Here, the volume unit may represent a three-dimensional spatial unit of a predefined size. Additionally, the importance may represent an importance of each vertex within the current region.

When calculating a local spatial characteristic for the current region, geometric information of a neighboring region or an entire region may be utilized. For example, a local spatial characteristic for the current region may be calculated based on a statics relating to geometric information between the neighboring region or the entire region, and the current region. The statistics may represent the vertex distribution per volume unit or the edge distribution per volume unit.

Based on at least one of a global spatial characteristic of the input mesh or a local spatial characteristic of the current region, at least one of whether to perform decimation or an intensity for the decimation may be determined for the current region S520. The current region represents a region among a plurality of regions for which at least one of whether to perform the decimation or an intensity of the decimation is determined.

Here, determining at least one of whether to perform decimation or an intensity of the decimation for each region may involve determining a decimation parameter for each region.

The decimation parameter is for controlling the decimation function and may include at least one of a decimation method, a target vertex count ratio, a target face count ratio, a target number of vertices, a target number of faces, a threshold value of an importance, a decimation iteration count, a decimation threshold, a minimum decimation iteration count, or a maximum decimation iteration count.

For example, the target face count ratio may represent the ratio between the number of faces to be obtained through mesh decimation and the number of faces in the original mesh. A target face count ratio of 1 may represent that decimation is not performed for the current region. On the other hand, a target face count ratio less than 1 indicates that the number of faces to be obtained through mesh decimation within the current region is smaller than the number of faces in the original mesh. As the value of the target face count ratio decreases, the rate of face reduction due to mesh decimation may increase. In other words, as the value of the target face count ratio gets smaller, the number of faces in the base mesh also gets smaller.

A decimation parameter may be determined for each region. For example, the target face count ratio may be adjusted for each region constituting the mesh.

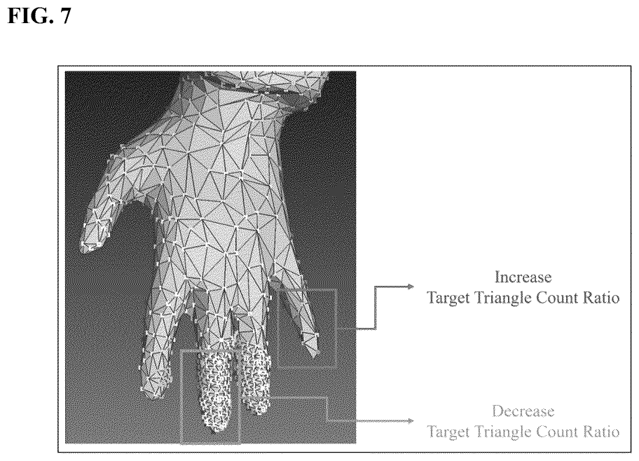

FIGS. 6 and 7 illustrate examples in which the target face count ratio is set differently for each region.

As illustrated in the examples in FIGS. 6 and 7, the face reduction rate may be set smaller for a region with high importance, and larger for a region with low importance.

Alternatively, the target face vertex ratio may be adjusted based on the importance of the current region.

For example, the importance of a vertex in the current region may be calculated, and then whether or not to delete the vertex may be determined based on the comparison of the importance of the vertex with a threshold. Specifically, if the importance of the vertex is greater than the threshold, the vertex is retained without deletion. On the other hand, if the importance of the vertex is less than the threshold, the vertex may be deleted.

Accordingly, if the importance of the current region is high, as many vertices as possible are retained. Conversely, if the importance of the current region is low, a large number of vertices may be removed.

By determining whether to perform mesh decimation or an intensity of mesh decimation for each region, it is possible to determine whether to modify or preserve vertices or faces constituting a region.

Here, modifying a vertex or face may include at least one of deleting, merging, or moving the vertex or face.

For example, assuming that each vertex constituting a mesh represents a separate region, whether to remove a vertex may be determined for each vertex. Specifically, whether to remove the current vertex may be determined based on the result of comparing the length of the edge originating from the current vertex with a threshold value.

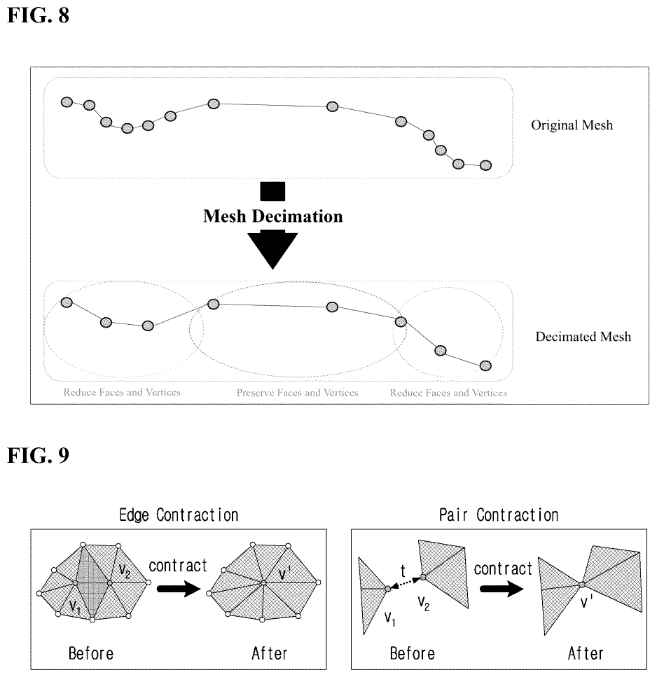

FIG. 8 illustrates an example in which whether to remove a current vertex is determined based on the result of comparing a length of an edge originating from the current vertex with a threshold.

If a length of an edge adjacent to the current vertex is greater than the threshold, the current vertex may be retained without deletion. Otherwise, the current vertex may be removed.

Meanwhile, the threshold may be predefined in the encoder and decoder, or automatically calculated according to a preset algorithm. Alternatively, the threshold may be set by external user input.

If mesh decimation is performed on the current region, a local spatial characteristic of the current region is updated based on a result of the mesh decimation. Based on the updated local spatial characteristic, whether to apply again mesh decimation to the current region may be determined. At this time, whether to apply again mesh decimation to the current region may be determined by comparing a local characteristic of the current region with a decimation threshold. The decimation threshold may be predefined or adaptively determined based on a local characteristic of the current region.

Alternatively, the number of iterations of mesh decimation may be determined based on a local spatial characteristic of the current region. Once the number of iterations of mesh decimation is determined, mesh decimation may be applied to the current region repeatedly for the determined number of iterations.

Alternatively, the minimum number of iterations of mesh decimation may be determined based on a local spatial characteristic of the current region. Once the minimum number of iterations of mesh decimation is determined, mesh decimation may be applied to the current region repeatedly for the determined minimum number of iterations. After mesh decimation has been performed for the minimum number of iterations, whether to apply again mesh decimation to the current region may be determined based on a local spatial characteristic of the current region.

Alternatively, the maximum number of iterations of mesh decimation may be determined based on the local spatial characteristic of the current region. Based on the local spatial characteristic of the current region, it may be determined whether to apply mesh decimation to the current region. If mesh decimation has been applied to the current region, the local spatial characteristic may be updated based on the decimated current region, and based on the updated local spatial characteristic, it may be determined whether to apply again mesh decimation to the current region. Meanwhile, if the number of iterations of mesh decimation has reached the maximum number of iterations, mesh decimation may no longer be applied to the current region without comparing the local spatial characteristic with a decimation threshold.

Meanwhile, determining whether to perform mesh decimation for each region or an intensity of the mesh decimation for each region may include determining whether to perform contraction for a region, the number of contraction iterations, and the minimum or maximum number of contraction iterations.

A contraction process is a kind of mesh decimation. Contraction may represent at least one of a pair contraction, which merges two vertices associated as a pair into a single vertex, or an edge contraction, which merges two vertices connected by an edge into a single vertex.

FIG. 9 illustrates examples of edge contraction and pair contraction.

For a region that satisfies certain conditions, i.e., a region with high importance, the contraction process is not performed, thereby preserving positions and shapes of existing vertices. Conversely, for a region that does not satisfy certain conditions, i.e., a region with low importance, the contraction process is repeatedly performed to simplify the mesh surface.

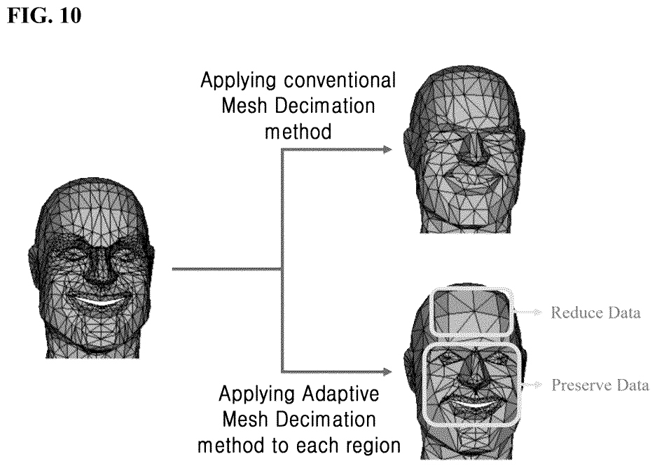

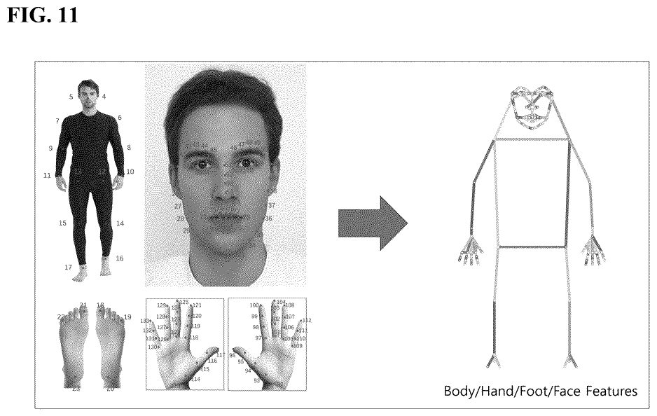

FIG. 10 illustrates an example in which whether to perform a contraction process, or the number of contraction operations is determined differently between regions.

As shown in the example in FIG. 10, for a region with high importance, contraction may be omitted or the number of contraction processes may be set to a small number, thereby preserving data within the region.

Conversely, for a region with low importance, the number of contraction processes can be set to a high number, thereby reducing the amount of data representing the region.

Whether to apply the contraction process to the current region may be determined based on a local spatial characteristic of the current region. If the contraction process is applied to the current region, the local spatial characteristic of the current region may be updated, and based on the updated local spatial characteristic, whether to re-perform the contraction process for the current region may be determined.

In the above example, it was explained that at least one of whether to perform mesh decimation or an intensity of mesh decimation is determined for each region based on a local spatial characteristic of each region.

Unlike the described example, at least one of whether to perform mesh decimation or an intensity of mesh decimation may be determined for an input mesh or each region of the input mesh using a coding performance metric. Here, the coding performance metric may include a rate-distortion ratio (RD cost).

For example, a plurality of coding performance metrics may be obtained by varying at least one of whether to perform mesh decimation or an intensity of mesh decimation. Then, based on the setting corresponding to the optimal coding performance metric, the decision on whether to perform mesh decimation or an intensity of mesh decimation may be determined for the input mesh.

For example, by comparing a coding performance metric for a current region without decimation with a coding performance metric for a current region with mesh decimation, it is determined whether to perform mesh decimation for the current region.

Alternatively, for the current region within the mesh, a plurality of coding performance metrics are obtained by varying at least one of whether to perform mesh decimation or an intensity of mesh decimation. Then, based on the setting corresponding to the optimal coding performance metric, the decision on whether to perform decimation or an intensity of the mesh decimation may be determined for the current region.

As another example, based on feature information of a mesh, at least one of whether to perform mesh decimation or an intensity of mesh decimation may be adaptively determined for a current region.

The feature information may include at least one of location information (e.g., coordinate information) of a feature point within the mesh, identification information (e.g., ID) of a feature point, motion information of a feature point, the type of a feature point, or connection information between feature points. Here, a feature point may represent a vertex with high importance within the mesh.

FIG. 11 illustrates feature points within a mesh.

If a mesh corresponds to an object such as a human or animal, at least one of a major joint or muscle location of the body, hands, feet, or face may be set as a feature point.

For a region where a distance from a feature point is less than a threshold (i.e., a region close to the feature point), mesh decimation may be omitted or an intensity of mesh decimation may be lowered to reduce the amount of data lost.

Conversely, for a region where a distance from a feature point is greater than or equal to a threshold (i.e., a region far away from the feature point), an intensity of mesh decimation may be increased to reduce the amount of data to be encoded/decoded.

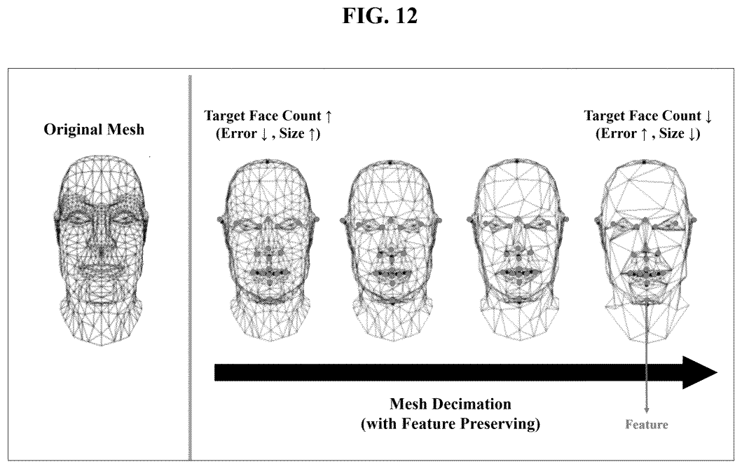

FIG. 12 illustrates an example in which an intensity of mesh decimation is set differently depending on a distance from a feature point.

For example, when mesh decimation is performed on a human object, geometric information in regions close to at least one of a major joint or muscle location of the body, hands, feet, and face may be preserved as much as possible, while the geometric information in other regions is decimated. This allows the overall amount of data to be encoded or decoded to be reduced while maintaining high precision for key parts of the human object.

Meanwhile, a weight may be applied to an intensity of mesh decimation based on a distance from a feature point.

Meanwhile, feature information may be encoded and signaled along with the mesh data. Here, the feature information may include information about feature points within the input mesh or the base mesh. For example, the mesh data and feature information may be fused, and the fused data may be encoded and signaled.

Alternatively, the mesh data and feature information may be encoded using separate encoders, and the encoded data may be multiplexed and signaled.

Alternatively, encoding/decoding of feature information may be omitted, and only the mesh data may be encoded/decoded.

Alternatively, feature information may be encoded and transmitted as data separately from the encoding and transmission of mesh data.

Alternatively, feature information may be predefined data stored in the encoder/decoder.

If an encoder does not transmit mesh decimation information to a decoder, the decoder may perform mesh subdivision, inverse-lifting, or inverse-quantization, independently, regardless of the mesh decimation results. Accordingly, the encoder also does not refer to the mesh decimation results when performing mesh subdivision, lifting, or quantization.

If mesh decimation results are not referenced during mesh subdivision, lifting, or quantization, encoding/decoding efficiency may deteriorate.

Therefore, the present disclosure proposes a method for an encoder to reference mesh decimation results for processes subsequent to mesh decimation, and a method for explicitly encoding and signaling mesh decimation information.

Mesh decimation information may be signaled by Video-based Dynamic Mesh Coding (V-DMC) syntax or in a Supplementary Enhanced Information (SEI) message. Furthermore, mesh decimation information may include a mesh decimation parameter. Based on the mesh decimation parameter, a decoder may check or derive at least one of whether mesh decimation is performed or an intensity of mesh decimation.

An encoder may control at least one of mesh subdivision, lifting, or quantization, or adjust a parameter related to at least one of mesh subdivision, lifting, or quantization, based on the mesh decimation information.

For example, the encoder may determine at least one of a mesh subdivision iteration count, a mesh subdivision method, or a subdivision edge length threshold based on the mesh decimation information.

For example, a mesh decimation parameter may be compared with a threshold value to determine whether to perform subdivision for an edge. Meanwhile, the threshold value may be predefined in the encoder and decoder, or derived based on the mesh decimation parameter. Alternatively, information indicating the threshold value may be encoded and signaled.

Similarly, a decoder may reference mesh decimation information to control at least one of mesh subdivision, inverse-lifting, or inverse-quantization. To this end, an encoder may encode and signal mesh decimation information for the entire mesh or for each region within the mesh.

Meanwhile, outlier information may be encoded and signaled. The outlier information may be signaled by V-DMC syntax or in a SEI messages.

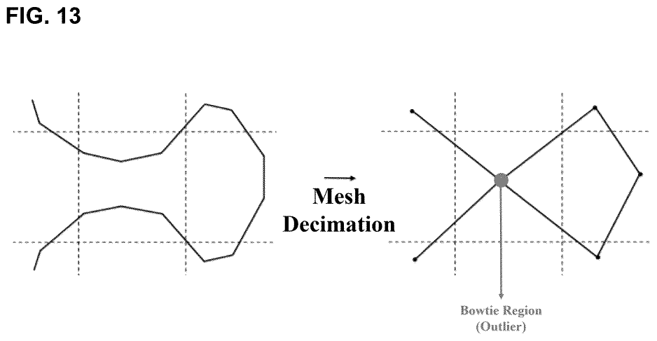

FIG. 13 illustrates an example of an abnormal region occurring due to mesh decimation.

Mesh decimation may cause mesh shape distortion, resulting in an unexpected abnormal region (e.g., a bowtie region or a degenerate triangle).

In FIG. 13, an example of a bowtie region occurring due to mesh decimation is illustrated.

FIG. 3 also illustrates an example of an abnormal region occurring due to mesh decimation.

An outlier may represent an abnormal region resulting from mesh decimation, or a vertex, polygon, or edge located within an abnormal region.

To improve the efficiency of subsequent processes following the mesh decimation process and improve mesh reconstruction quality, the encoder may explicitly encode and signal outlier information.

Furthermore, an encoder may perform outlier processing based on the outlier information. Outlier processing may include at least one of the following:

### 1) Filtering Based on Threshold Value

This is used to remove or correct a vertex or region determined as an outlier after mesh decimation.

### 2) Remapping or Smoothing

This process represents remapping or smoothing vertices or regions determined as outliers to match surrounding regions after mesh decimation. This process maintains the structural consistency of the mesh.

### 3) Mesh Subdivision

After mesh decimation, when applying mesh subdivision to a base mesh, a vertex or region determined as an outlier may not be split or deformed.

A decoder, like an encoder, may perform at least one of threshold-based filtering, remapping or smoothing, or mesh subdivision, referencing outlier information.

The outlier information and mesh data can be fused, and then the fused data may be encoded and signaled.

Alternatively, the mesh data and outlier information may be encoded using separate encoders, and the encoded data may be multiplexed and signaled.

Alternatively, encoding/decoding of the outlier information may be omitted, and only the mesh data may be encoded/decoded.

Alternatively, the outlier information may be encoded and transmitted as data separately from the encoding and transmission of the mesh data.

Alternatively, the outlier information may be predefined in the encoder/decoder.

Conventional video codec or point cloud codec adopts a hierarchical partitioning structure. The hierarchical partitioning structure allows for high compression ratios by controlling encoding operations on a coding unit (CU) basis. For example, for a coding unit with high importance, the amount of information to be encoded/decoded may be increased, while for a coding unit with low importance, the amount of information to be encoded/decoded may be reduced, thereby maintaining high quality in the reconstructed image.

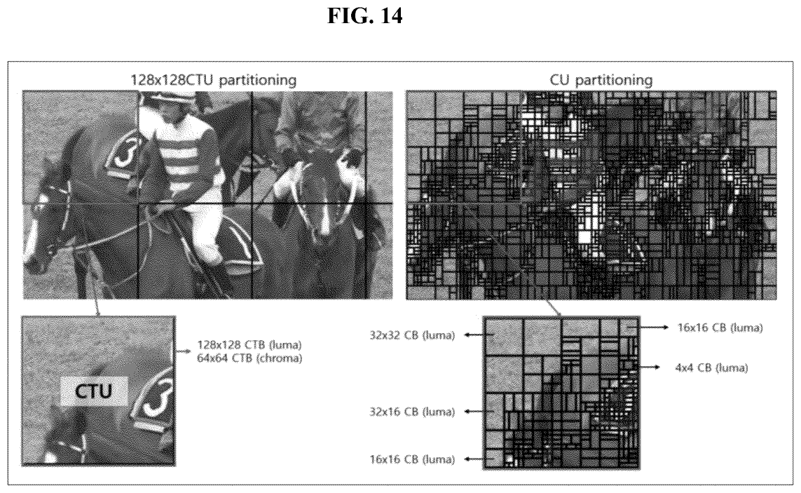

FIG. 14 illustrates hierarchical partitioning of an image.

Meanwhile, a single mesh may be divided into multiple sub-meshes, and a plurality of sub-meshes may be independently encoded/decoded and transmitted.

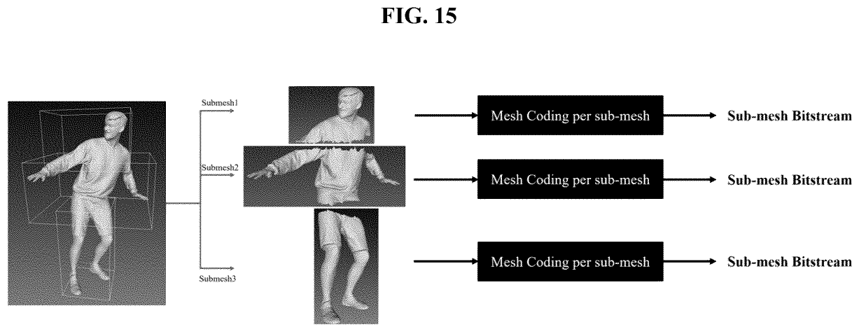

FIG. 15 illustrates an example of a mesh divided into a plurality of sub-meshes.

In addition to the sub-mesh partitioning structure, the present disclosure proposes a method of adopting a block partitioning structure of conventional codec for encoding/decoding of the mesh to provide greater flexibility in encoding/decoding of mesh.

Specifically, the present disclosure proposes a coding unit partitioning method for geometric information.

Based on spatial characteristics, geometric information may be partitioned into a plurality of coding units to enable more precise control of the encoding operation.

For example, a mesh may be partitioned into a plurality of spaces of uniform size. Each space may be defined as a Geometry Coding Unit (GCU).

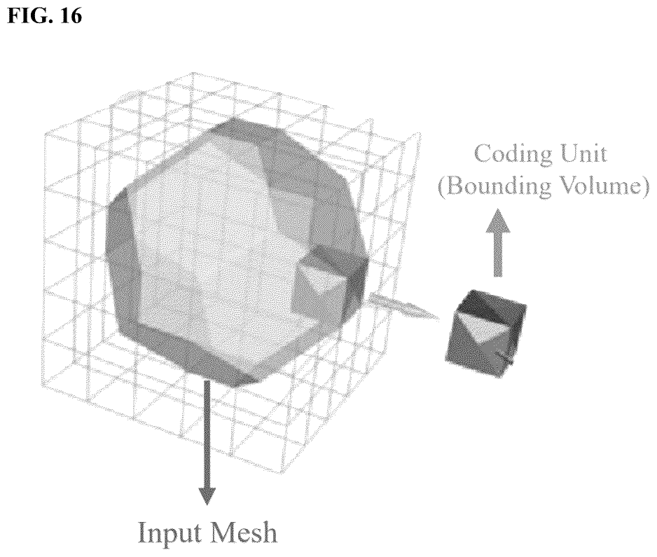

FIG. 16 illustrates an example of partitioning an input mesh into a plurality of GCUs.

Here, the input mesh may be an original mesh, a base mesh, a subdivided mesh, or a reconstructed mesh.

Each space may be a 3D shape of a fixed size (e.g., a cube or a tetrahedron).

The input mesh may be divided into a plurality of GCUs based on a bounding volume of a fixed size.

As another example, the input mesh may be partitioned into a plurality of spaces of non-uniform size. Each space may correspond to a GCU.

By dividing the input mesh into a plurality of spaces of non-uniform size, at least one of a size or shape may differ between the spaces.

Alternatively, a decimated 3D polygon obtained through mesh decimation or a bounding box surrounding the 3D polygon may be defined as a GCU.

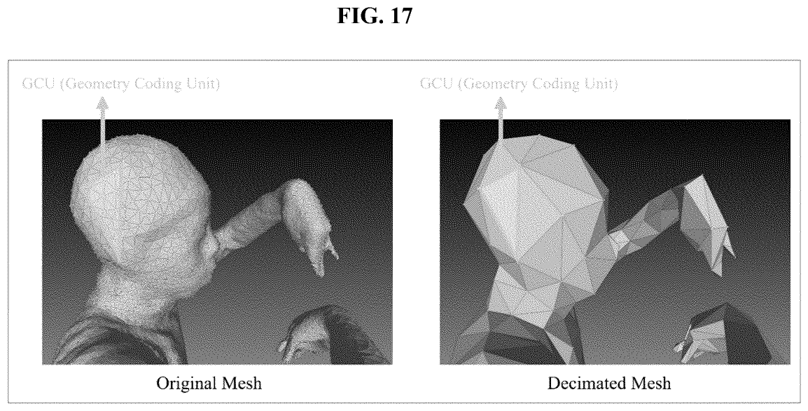

FIG. 17 illustrates an example of setting a decimated 3D polygon obtained through mesh decimation as a GCU.

Each face (i.e., triangle) of a base mesh (i.e., decimated mesh) obtained through mesh decimation may be set as a geometry coding unit (i.e., GCU).

Meanwhile, a GCU may be recursively partitioned. That is, by additionally partitioning a GCU, a plurality of GCUs (or a plurality of sub-GCUs) may be generated.

For example, whether to partition a decimated face additionally may be determined. If it is decided to partition a face, the face is partitioned into a plurality of faces and each of the plurality of faces may be set as a geometry coding unit (i.e., GCU).

At least one of a prediction mode, the number of mesh subdivision iterations, the mesh subdivision method, the subdivision edge length threshold, the lifting method, or the transformation method may be determined for each GCU. The encoder may determine at least one of the enumerated factors based on the RD cost.

As another example, a GCU may be determined based on the bounding volume hierarchy (BVH) partitioning structure.

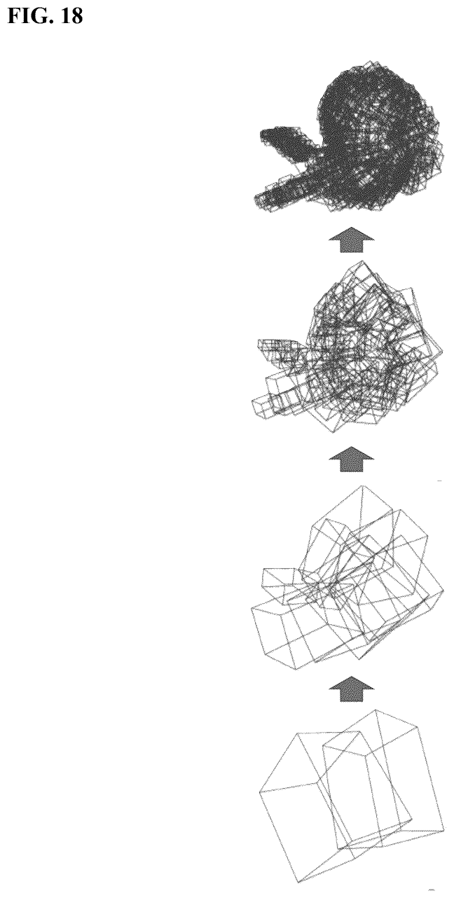

FIG. 18 illustrates an example of determining a GCU based on the BVH partitioning structure.

As shown in the example in FIG. 18, a bounding box may be recursively partitioned into a plurality of bounding boxes. GCUs may be determined through the hierarchical partitioning structure.

When GCUs are set based on a bounding volume, the bounding volume may be set based on a global origin coordinate system or an orientation of a mesh object.

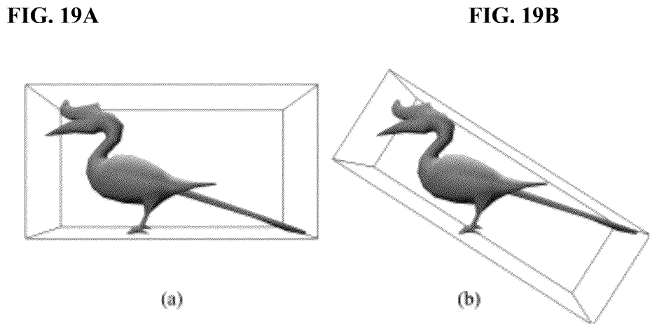

FIGS. 19A and 19B illustrate an example of setting a bounding volume.

FIG. 19A illustrates an example of setting a bounding volume based on the global origin coordinate system, while FIG. 19B illustrates an example of setting a bounding volume based on the orientation of a mesh object.

As another example, GCUs may be determined based on feature information in mesh data.

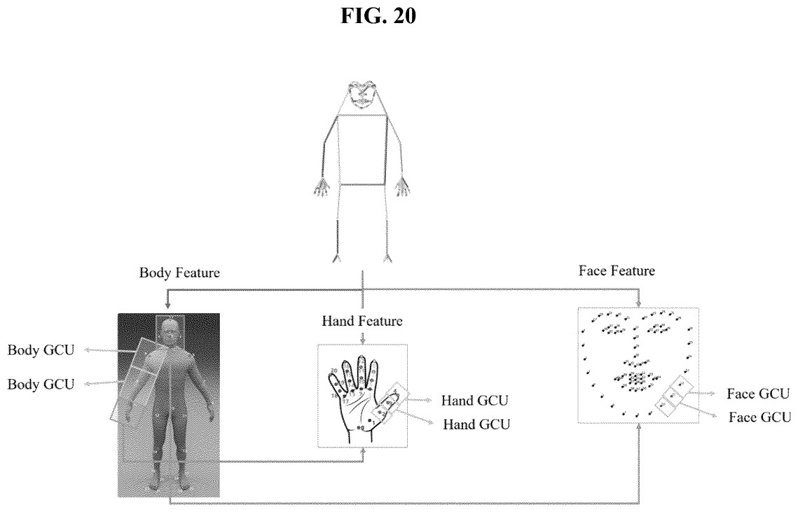

FIG. 20 illustrates an example of determining GCUs based on feature information.

As illustrated in the example in FIG. 20, when feature points are located on a body, hands, feet, or face of object, mesh data may be partitioned based on the feature points. For example, each region containing a feature point may be designated as a GCU.

In regions requiring high precision, such as the face or hands, a GCU may be recursively partitioned to generate high-precision GCUs.

An encoder may encode and signal information on coding unit partitioning structure of a mesh. The coding unit partitioning information may include at least one of a partitioning method, a partitioning depth, a partitioning hierarchy structure, a maximum depth of the partitioning tree, a minimum depth of the partitioning tree, a partitioning direction of a GCU, or a reference coordinate of a GCU.

Alternatively, for each coding unit, information on at least one of a size of a unit, a position of a unit, or an order of a unit may be encoded and signaled.

The decoder may partition the mesh, based on coding unit partitioning information, so as to have the same mesh partitioning structure as the encoder.

A coding parameter may be encoded and signaled for each GCU. For example, at least one of a prediction parameter, a mesh subdivision parameter, a transformation parameter, or a quantization parameter may be encoded and signaled for each GCU. Accordingly, the coding parameter may differ for each GCU.

Here, the prediction parameter may include at least one of a prediction mode, a prediction direction, or a motion vector. The mesh subdivision parameter may include at least one of the number of mesh subdivision iterations or a mesh subdivision method. The transformation parameter may include at least one of a lifting method, a lifting weight, or a lifting offset. The quantization parameter may include at least one of a lifting quantization parameter (Lifting QP), an adaptive scale, a quantization bias, or a quantization offset.

According to the present disclosure, by providing a method for determining whether to perform mesh decimation or an intensity of mesh decimation for each region, there is an effect of improving the quality of reconstructed mesh while increasing encoding/decoding efficiency.

According to the present disclosure, encoding/decoding efficiency may be improved by performing mesh subdivision, mesh transformation, or mesh quantization based on mesh decimation information.

According to the present disclosure, encoding/decoding efficiency may be improved by providing a method for partitioning an input mesh into a plurality of coding units and then encoding/decoding a coding parameter in units of coding units.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of encoding a dynamic mesh, comprising:
obtaining a base mesh from an input mesh;
subdividing the base mesh;
generating displacement information based on subdivided mesh; and
encoding the base mesh and the displacement information,
wherein the base mesh is obtained by performing mesh decimation on the input mesh, and
wherein a decimation parameter for the mesh decimation is determined in a unit of region in the input mesh.

2. The method of claim 1, a decimation parameter for a current region in the input mesh is determined based on a local spatial characteristic of the current region.

3. The method of claim 2, wherein the local spatial characteristic comprises at least one of a number of vertices in the current region, a number of faces in the current region, a number of edges in the current region, a length of an edge or an importance of the current region.

4. The method of claim 2, wherein the decimation parameter comprises at least one of a target vertex count ratio, a target face count ratio, a target number of vertices, a target number of faces or a threshold value of an importance,
wherein the target vertex count ratio represents a ratio between a number of vertices in the current region in the input mesh and a number of vertices in the current region in a decimated mesh, and
wherein the target face count ratio represent a ratio between a number of faces in the current region in the input mesh and a number of faces in the current region in the decimated mesh.

5. The method of claim 1, wherein, based on a comparison result between a length of an edge in the current region with a threshold value, it is determined whether to remove a vertex constituting the edge.

6. The method of claim 5, wherein when the length of the edge is greater than the threshold value, the vertex is preserved, and
wherein when the length of the edge is equal to or less than the threshold value, the vertex is removed.

7. The method of claim 1, wherein the decimation parameter comprises at least one of information indicating whether to perform a contraction, a number of iterations for the contraction, a minimum number of iterations for the contraction, a maximum number of iterations for the contraction or a threshold value of an importance.

8. The method of claim 7, wherein when it is determined to perform the contraction for the current region, at least one of a pair contraction or an edge contraction is performed for the current region.

9. The method of claim 1, wherein, after performing the contraction for the current region, the local spatial characteristic of the current region is updated, and
wherein, based on the updated local spatial characteristic, it is determined whether the contraction is to be performed again for the current region.

10. The method of claim 1, wherein a decimation parameter for a current region in the input mesh is determined by comparing a plurality of coding performance metrics for the current region.

11. The method of claim 10, wherein the coding performance metrics represent rate-distortion costs obtained by varying a decimation parameter for the current region.

12. The method of claim 11, wherein the decimation parameter for the current region is determined based on a setting used to obtain an optimal coding performance metric among the plurality of coding performance metrics.

13. The method of claim 1, wherein the method further comprises encoding mesh decimation information, and
wherein the mesh decimation information is encoded and signaled for each region.

14. The method of claim 1, wherein based on the decimation parameter, at least one of a number of iterations for the subdivision, a subdivision method or a subdivision edge length threshold is determined.

15. The method of claim 1, wherein the method further comprises encoding outlier information, and
wherein the outlier information represents information about an abnormal vertex or region resulting from the mesh decimation.

16. The method of claim 1, wherein the method further comprises encoding feature information, and
wherein the feature information comprises information on vertices with high importance in the input mesh or the base mesh.

17. The method of claim 1, wherein the base mesh, the subdivided mesh or a reconstructed mesh is partitioned into a plurality of geometric coding units.

18. The method of claim 17, wherein the plurality of geometric coding units represent polygons resulting from the mesh decimation or bounding boxes, each of which includes a polygon resulting from the mesh decimation.

19. A device for encoding a dynamic mesh, comprising:
a pre-processing unit configured to:
obtain a base mesh from an input mesh,
subdivide the base mesh, and
generate displacement information based on a subdivided mesh;
a base mesh encoding unit configured to encode the base mesh; and
a displacement information encoding unit configured to encode the displacement information,
wherein a decimation parameter for the mesh decimation is determined in a unit of region in the input mesh.

20. A non-transitory computer readable medium storing instructions when executed case the computer to carry out an encoding method comprising:
obtaining a base mesh from an input mesh;
subdividing the base mesh;
generating displacement information based on subdivided mesh; and
encoding the base mesh and the displacement information,
wherein the base mesh is obtained by performing mesh decimation on the input mesh, and
wherein a decimation parameter for the mesh decimation is determined in a unit of region in the input mesh.
